(19) United States
(12) Patent Application Publication
(10) Pub. No.: US 2010/0206151 A1
(43) Pub. Date: Aug. 19, 2010

(54) QUICK-DETACHABLE SAW BLADE GUARD ASSEMBLY FOR CIRCULAR SAW

(75) Inventor: Long-Chang Jan, Changhua County (TW)

Correspondence Address: BROWDY AND NEIMARK, P.L.L.C.;624 NINTH STREET, NW, SUITE 300, WASHINGTON, DC, 20001-5303, US

(73) Assignee: OAV EQUIPMENT & TOOLS, INC., Shen Kang Hsiang (TW)

(21) Appl. No.: 12/411,054

(22) Filed: Mar. 25, 2009

(30) Foreign Application Priority Data
Feb. 18, 2009 (TW) 98202364

(51) Int. Cl. B26D 7/22

(52) U.S. Cl. 83/478

(57) ABSTRACT

A quick-detachable saw blade guard assembly used in a circular saw to guard a saw blade is disclosed to include a spreader having a first locating notch and a second locating notch that defines an opening, a support bar having a bar member and a pivot transversely fastened to one end of the bar member and detachably movably coupled to the first locating notch of the spreader, a saw blade guard mounted on the support bar for guarding the spreader and the saw blade, a locking device having a locking plate movable relative to the bar member and a pin fastened to the locking plate and movable in and out of the second locating notch through the opening, and a control device having an adjustment member mounted on the bar member for engaging the locking plate to hold the pin of the locking device in the second locating notch of the spreader.

### BACKGROUND OF THE INVENTION

1. Field of the Invention

The present invention relates to saw machines and more particularly, to a quick-detachable saw blade guard assembly for use in a circular saw.

2. Description of the Related Art

A saw machine generally uses a spreader to prevent the saw blade from jamming in the cut. To achieve a simple design, some saw machines have the saw blade guard be directly mounted on the spreader.

However, the saw blade guard of a conventional saw machine that is directly mounted on the spreader is not detachable from the spreader. It is inconvenient to remove the saw blade guard from the spreader. In case the saw blade guard is damaged, the user may be not willing to replace the damaged saw blade guard. However, it is dangerous to use a saw machine without a saw blade guard or with a damaged saw blade guard.

### SUMMARY OF THE INVENTION

The present invention has been accomplished under the circumstances in view. It is therefore the main object of the present invention to provide a quick-detachable saw blade guard assembly, which can be quickly and positively mounted on a spreader to guard a saw blade, and quickly detached from the spreader.

To achieve this and other objects of the present invention, a quick-detachable saw blade guard assembly is used in a circular saw to guard a saw blade, comprising a spreader having a first locating notch and a second locating notch that defines an opening, a support bar having a bar member and a pivot transversely fastened to one end of the bar member and detachably movably coupled to the first locating notch of the spreader, a saw blade guard mounted on the support bar for guarding the spreader and the saw blade, a locking device having a locking plate movable relative to the bar member and a pin fastened to the locking plate and movable in and out of the second locating notch through the opening, and a control device having an adjustment member mounted on the bar member for engaging the locking plate to hold the pin of the locking device in the second locating notch of the spreader.

Further, the first locating notch of the spreader defines an opening through which the pivot of the support bar is movable in and out of the first locating notch.

Further, the spreader comprises a beveled edge located on one side of the opening of the first locating notch.

Further, the spreader comprises a beveled edge located on one side of the opening of the second locating notch.

Further, the bar member of the support bar is a channel bar having a substantially U-shaped cross section.

Further, the bar member of the support bar comprises an elongated sliding slot, the pin of the locking device is inserted through the elongated sliding slot of the bar member.

Further, the saw blade guard comprises at least one guard plate, and a plurality of links respectively pivotally connected between the at least one guard plate and the bar member of the support bar.

Further, the number of the at least one guard plate of the saw blade guard can be 2, and the two guard plates are arranged at two opposite sides relative to the bar member of the support bar.

Further, the locking plate has a substantially U-shaped cross section.

Further, the locking plate is coupled to and movable along the bar member of the support bar.

Further, the locking device comprises a finger strip for operation by a hand of a person to move the locking plate relative to the bar member of the support bar.

Further, the locking device comprises a spring member adapted for forcing the pin into the second locating notch of the spreader.

Further, the adjustment member of the control device is a rotary knob pivotally fastened to the bar member of the support bar by a pivot bolt.

Further, the adjustment member comprises an escape spaced from the engagement portion of the adjustment member at a predetermined radial direction.

### BRIEF DESCRIPTION OF THE DRAWINGS

FIG. 1 is an elevational assembly view of a quick-detachable saw blade guard assembly for circular saw in accordance with the present invention.

FIG. 2 is an exploded view of the quick-detachable saw blade guard assembly for circular saw in accordance with the present invention.

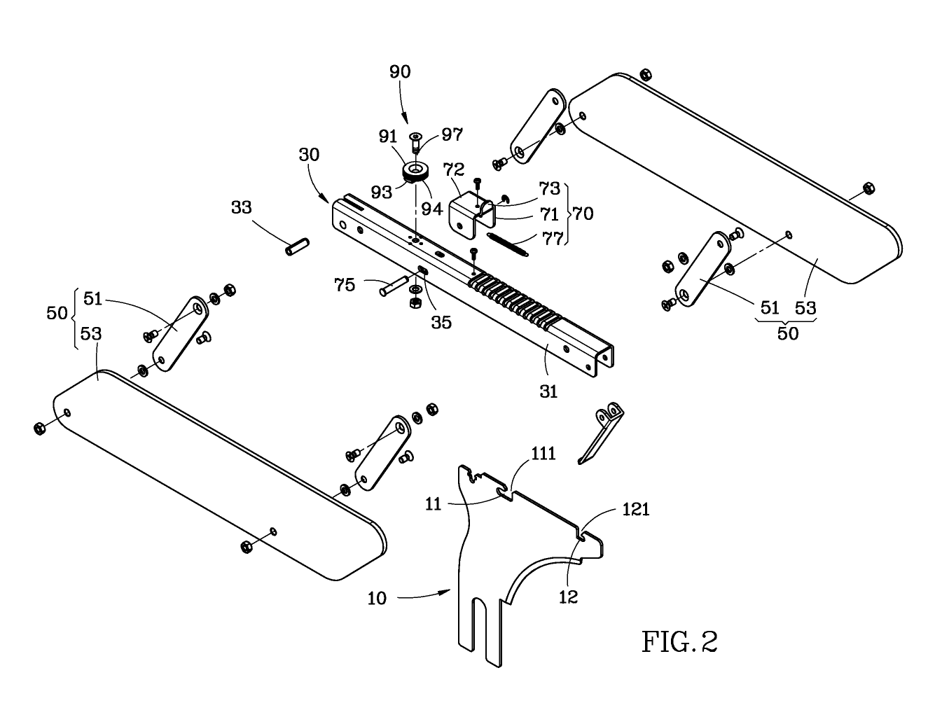

FIG. 3 is a schematic front view of the quick-detachable saw blade guard assembly for circular saw in accordance with the present invention.

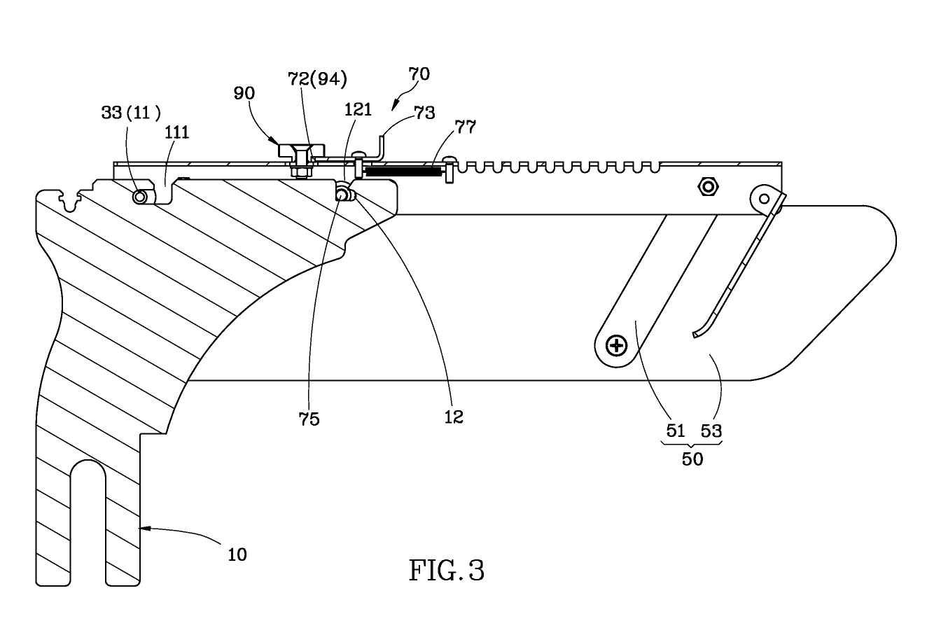

FIG. 4 is a top view of the quick-detachable saw blade guard assembly for circular saw in accordance with the present invention.

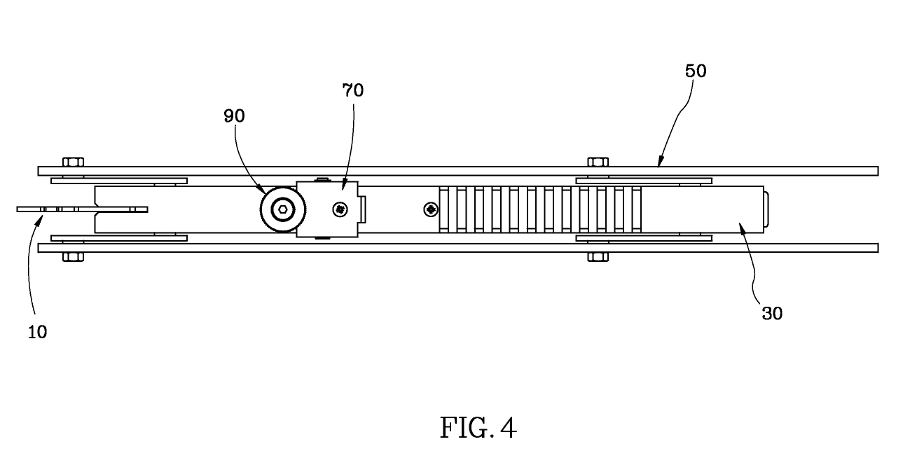

FIG. 5 is similar to FIG. 3, but showing the locking plate in the unlocked position.

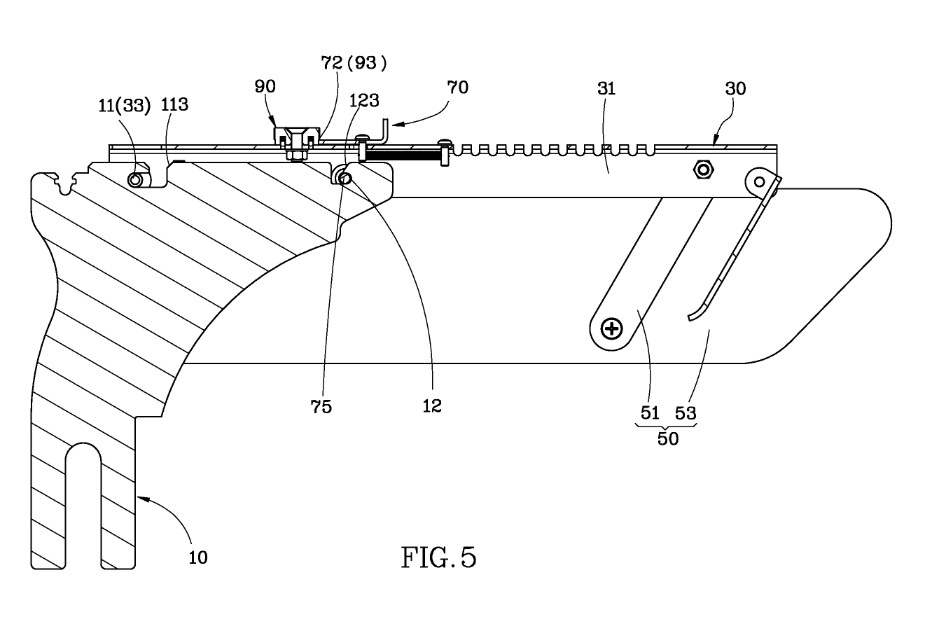

### DETAILED DESCRIPTION OF THE INVENTION

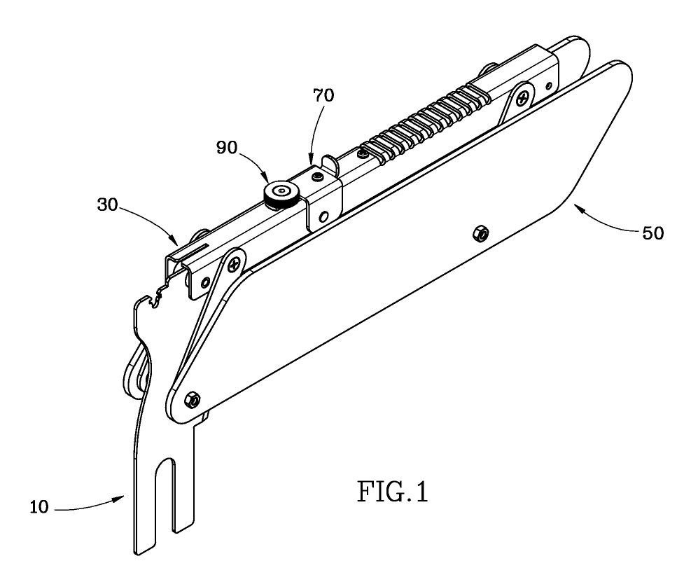

Referring to FIGS. 1˜5, the invention provides a quick-detachable saw blade guard assembly for use in a circular saw (not shown) to protect a saw blade (not shown). The saw blade guard assembly comprises a spreader 10, a support bar 30, a saw blade guard 50, a locking device 70, and a control device 90.

The spreader 10 has a first locating notch 11 defining a first opening 111, a second locating notch 12 defining a second opening 121, a first beveled edge 113 located on one side of the first opening 111, and a second beveled edge 123 located on one side of the second opening 121.

The support bar 30 comprises a bar member 31, and a pivot 33 transversely fastened to one end of the bar member 31 and detachably movably coupled to the first locating notch 11 of the spreader 10. The bar member 31 is a channel bar having a substantially U-shaped cross section and an elongated sliding slot 35 cut through each of the two opposite sidewalls thereof. The first opening 111 of the spreader 10 allows the pivot 33 of the support bar 30 to be moved in and out of the first locating notch 11 conveniently.

The saw blade guard 50 is adapted for guarding the spreader 10 and the saw blade of the circular saw. The saw blade guard 50 comprises two guard plates 53 arranged at two opposite sides relative to the support bar 30, and a plurality of links 51 pivotally connected between the guard plates 53 and the bar member 31 of the support bar 30.

The locking device 70 comprises a locking plate 71, a pin 75, and a spring member 77. The locking plate 71 is a substantially U-shaped plate member mounted on and movable along the bar member 31 of the support bar 30, having an engagement portion 72 located on the front side and a finger strip 73 extended from the rear side. By means of the finger strip 73, a user can move the locking plate 71 along the bar member 31 conveniently. The pin 75 is inserted through the elongated sliding slot 35 on each of the two opposite sidewalls of the bar member 31 and fixedly connected between the two opposite sidewalls of the U-shaped locking plate 71. The spring member 77 is adapted to force the pin 75 into the second locating notch 12 of the spreader 10.

The control device 90 comprises an adjustment member 91 and a pivot bolt 97. The adjustment member 91 is a rotary knob mounted on the bar member 31 of the support bar 30 and rotatable relative to the support bar 30. The pivot bolt 97 is inserted through the adjustment member 91 and threaded into the top wall of the bar member 71 to secure the adjustment member 91 to the bar member 31 pivotally. The adjustment member 91 has an engagement portion 93 for engaging the engagement portion 72 of the locking plate 71 to hold the pin 75 in the second locating notch 12 of the spreader 10, and an escape 94 formed on the periphery and spaced from the engagement portion 93 at a predetermined angle.

The installation and use of the saw blade guard assembly are outlined hereinafter. During installation, force the pivot 33 of the support bar 30 through the first opening 111 into the first locating notch 111, and then force the pin 75 into the second opening 121. At this time, the spring member 77 pulls the pin 75 rightwards into the second locating notch 12 of the spreader 10. Thereafter, rotate the adjustment member 91 to force the engagement portion 93 of the adjustment member 91 into engagement with the engagement portion 70 of the locking plate 71. Thus, the locking device 70 is locked.

When dismounting the saw blade guard assembly, rotate the adjustment member 91 to disengage the engagement portion 93 of the adjustment member 91 from the engagement with the engagement portion 70 of the locking plate 71 and to move the escape 94 to the engagement portion 70 of the locking plate 71, and then pull the finger strip 73 to move the locking plate 71 leftwards against the spring force of the spring member 77. Thus, the locking device 70 is unlocked. Thereafter, bias the support bar 30 to move the pin 75 out of the second locating notch 12 and second opening 121 of the spreader 10, and then shift the support bar 30 rightwards to move the pivot 33 out of the first locating notch 11 and first opening 111 of the spreader 10. Thus, the dismounting operation of the saw blade guard assembly is done.

Based on the aforesaid operation method and results, the quick-detachable saw blade guard assembly shows the advantages of simple structure and ease of operation, allowing quick and accurate mounting and dismounting.

Further, the two guard plates 53 of the saw blade guard 50 can be in integrity, i.e., the saw blade guard 50 can be a single-piece guard.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A quick-detachable saw blade guard assembly used in a circular saw for guarding a saw blade, the quick-detachable saw blade guard assembly comprising:
a spreader, said spreader comprising a first locating notch, a second locating notch, said second locating notch defining an opening;
a support bar, said support bar comprising a bar member and a pivot transversely fastened to one end of said bar member and detachably movably coupled to the first locating notch of said spreader;
a saw blade guard mounted on said support bar for guarding said spreader and said saw blade;
a locking device, said locking device comprising a locking plate movable relative to the bar member of said support bar, a pin fastened to said locking plate and movable in and out of said second locating notch through the opening, said locking plate comprising an engagement portion; and
a control device, said control device comprising an adjustment member mounted on the bar member of said support bar, said adjustment member comprising an engagement portion movable with said adjustment member relative to said bar member for engaging the engagement portion of said locking plate of the locking device to hold the pin of said locking device in the second locating notch of said spreader.

2. The quick-detachable saw blade guard assembly as claimed in claim 1, wherein said spreader further comprises a beveled edge located on one side of the opening of said second locating notch.

3. The quick-detachable saw blade guard assembly as claimed in claim 2, wherein the adjustment member of said control device is a rotary knob pivotally fastened to the bar member of said support bar by a pivot bolt.

4. The quick-detachable saw blade guard assembly as claimed in claim 3, wherein said adjustment member further comprises an escape spaced from the engagement portion of said adjustment member at a predetermined radial direction.

5. The quick-detachable saw blade guard assembly as claimed in claim 3, wherein said locking plate is coupled to and movable along the bar member of said support bar.

6. The quick-detachable saw blade guard assembly as claimed in claim 1, wherein the first locating notch of said spreader defines an opening through which the pivot of said support bar is movable in and out of said first locating notch.

7. The quick-detachable saw blade guard assembly as claimed in claim 6, wherein said spreader further comprises a beveled edge located on one side of the opening of said second locating notch.

8. The quick-detachable saw blade guard assembly as claimed in claim 6, wherein said spreader further comprises a beveled edge located on one side of the opening of said first locating notch.

9. The quick-detachable saw blade guard assembly as claimed in claim 8, wherein said spreader further comprises a beveled edge located on one side of the opening of said second locating notch.

10. The quick-detachable saw blade guard assembly as claimed in claim 9, wherein the adjustment member of said control device is a rotary knob pivotally fastened to the bar member of said support bar by a pivot bolt.

11. The quick-detachable saw blade guard assembly as claimed in claim 10, wherein said adjustment member further comprises an escape spaced from the engagement portion of said adjustment member at a predetermined radial direction.

12. The quick-detachable saw blade guard assembly as claimed in claim 10, wherein said locking plate is coupled to and movable along the bar member of said support bar.

13. The quick-detachable saw blade guard assembly as claimed in claim 1, wherein the adjustment member of said control device is a rotary knob pivotally fastened to the bar member of said support bar by a pivot bolt.

14. The quick-detachable saw blade guard assembly as claimed in claim 13, wherein said adjustment member further comprises an escape spaced from the engagement portion of said adjustment member at a predetermined radial direction.

15. The quick-detachable saw blade guard assembly as claimed in claim 14, wherein said locking plate is coupled to and movable along the bar member of said support bar.

16. The quick-detachable saw blade guard assembly as claimed in claim 13, wherein said locking plate is coupled to and movable along the bar member of said support bar.

17. The quick-detachable saw blade guard assembly as claimed in claim 1, wherein the bar member of said support bar comprises an elongated sliding slot; the pin of said locking device is inserted through the elongated sliding slot of said bar member.

18. The quick-detachable saw blade guard assembly as claimed in claim 1, wherein said locking plate is coupled to and movable along the bar member of said support bar.

19. The quick-detachable saw blade guard assembly as claimed in claim 1, wherein said locking device further comprises a finger strip for operation by a hand of a person to move said locking plate relative to the bar member of said support bar.

20. The quick-detachable saw blade guard assembly as claimed in claim 1, wherein said locking device further comprises a spring member adapted for forcing said pin into the second locating notch of said spreader.
